(19) United States
(12) Patent Application Publication
(10) Pub. No.: US 2018/0041736 A1
(43) Pub. Date: Feb. 8, 2018

(54) SURVEILLANCE CAMERA AND METHOD OF AUTONOMOUSLY CAPTURING IMAGES USING SAME

(71) Applicant: 9138-4529 QUÉBEC INC., Victoriaville (CA)

(72) Inventors: Yan GAGNON, Victoriaville (CA); François DION, Victoriaville (CA); Jérôme RANCOURT, Victoriaville (CA)

(21) Appl. No.: 15/469,175

(22) Filed: Mar. 24, 2017

Related U.S. Application Data
(60) Provisional application No. 62/369,985, filed on Aug. 2, 2016.

(51) Int. Cl. H04N 7/18; H02J 7/35; H04N 5/232

(52) U.S. Cl. CPC H04N 7/188; H04N 7/183; H04N 5/23245; H04N 5/23241; H02J 7/35

(57) ABSTRACT

A surveillance camera has a power unit; a control unit selectively powered by the power unit; a subject detection sensor powered by the power unit; and an image sensor operatively connected to the subject detection sensor and the control unit. The subject detection sensor detects a presence of a subject within limits of subject detection parameters and a length of time wherein the subject detection sensor detects the presence of the subject within the limits of the subject detection parameters defines a subject detection time period. The image sensor and the control unit are constantly activated by the power unit during the subject detection time period where the subject detection sensor detects the presence of the subject within the limits of the subject detection parameters.

### CROSS REFERENCE TO RELATED APPLICATION

This application claims the benefit under 35 U.S.C. § 119(e) of U.S. provisional patent application No. 62/369.985 which was filed on Aug. 2, 2016. The entirety of the aforementioned application is herein incorporated by reference.

### FIELD OF THE INVENTION

The present invention relates to the field of surveillance camera. More particularly, it relates to an autonomous motion sensing digital camera having a minimized trigger time and/or recovery time and to a method of autonomously capturing images using the same.

### BACKGROUND

Surveillance cameras are commonly used, for example and without being limitative, for capturing images of subjects in the context of hunting, general wildlife surveillance, security purposes or the like. In many cases, such surveillance cameras are initially set in a desired location where monitoring is desired and subsequently left unattended during extended surveillance time periods where surveillance can be performed using the camera.

In many cases, especially in the field of hunting and wildlife surveillance, the location where the camera is set can be a remote location where external electrical power is unavailable, such as a forest, a field or the like. Therefore, in such cases, surveillance cameras can be required to operate autonomously for extended time periods. On the other hand, to allow easy transportation, easy installation (often in heights to offer increased camouflage of the camera) and good concealment properties, the surveillance cameras (and the associated batteries) need to remain of a reasonable size (i.e. the camera should not be too cumbersome to displace and manipulate). In other words, in view of the above, it will be understood that to be attractive to consumers, surveillance cameras should offer an extended battery life while having a battery (or battery set) of a reasonable size not to impact the portability of the camera negatively.

Regarding the prolonged battery life, it is known to allow the surveillance camera to operate in a “sleep mode” (i.e. a mode with low power consumption) during time periods between triggers of the surveillance camera where it is operative to capture images or videos. However, since the camera is required to be brought from the “sleep mode” to an “active mode” (i.e. a state where the camera is operative to capture images or video) before a picture or video can be taken, the use of such low power “sleep modes” usually negatively impacts on the trigger time (i.e. the lapse of time between motion detection and the capture of a picture by the surveillance camera) and/or the recovery time (i.e. the lapse of time between motion detection and when the surveillance camera is ready to trigger again (including the trigger time)) of the surveillance camera.

In view of the above, known surveillance cameras, for example and without being limitative, for capturing images of wildlife or the like, tend to suffer from several drawbacks. For example, known surveillance cameras tend to offer a battery life that is insufficient for extended surveillance time periods where no external power source is available. Moreover, when sleep modes are used to improve the battery life without impacting on the battery size (i.e. without requiring an increase in the battery size), the resulting surveillance cameras tend to have a greater trigger time and/or recovery time, which is undesirable as it is during these periods that the camera consumes the most energy.

In view of the above, there is a need for an improved surveillance camera which, by virtue of its design and components, would be able to overcome or at least minimize some of the above-discussed prior art concerns.

### SUMMARY OF THE INVENTION

In accordance with a first general aspect, there is provided a surveillance camera. The surveillance camera comprises a power unit; a control unit selectively powered by the power unit; a subject detection sensor powered by the power unit; and an image sensor operatively connected to the subject detection sensor and the control unit. The subject detection sensor detects a presence of a subject within limits of subject detection parameters and a length of time wherein the subject detection sensor detects the presence of the subject within the limits of the subject detection parameters defines a subject detection time period. The image sensor and the control unit are constantly activated by the power unit during the subject detection time period where the subject detection sensor detects the presence of the subject within the limits of the subject detection parameters.

In an embodiment, the control unit comprises a microcontroller and a main processor operatively connected to one another. The microcontroller and the main processor are constantly activated by the power unit during the subject detection time period where the subject detection sensor detects the presence of the subject within the limits of the subject detection parameters.

In an embodiment, the surveillance camera is configurable between an active mode and a sleep mode with the surveillance camera having a lower power consumption in the sleep mode than in the active mode. The control unit is configured to perform transition of the surveillance camera from the sleep mode to the active mode upon detection of the presence of a subject within the limits of the subject detection parameters by the subject detection sensor.

In an embodiment, the main processor is operatively connected to a combination of a serial flash memory and a parallel flash memory and instructions executable by the main processor for performing transition between the sleep mode and the active mode are stored on the combination of the serial flash memory and the parallel flash memory.

In an embodiment, the main processor is configured to initially execute the instructions stored on the serial flash memory and subsequently execute the instructions stored on the parallel flash memory to perform the transition of the surveillance camera between the sleep mode and the active mode.

In an embodiment, the control unit is configured to transition the surveillance camera between the active mode and the sleep mode following an absence of detection of the presence of the subject within the limits of the subject detection parameters by the subject detection sensor during a time period equal or greater than a pre-set non-detection time period.

In an embodiment, the non-detection time period ranges between about 40 milliseconds and about 100 milliseconds.

In an embodiment, the surveillance camera comprises a photovoltaic module charging the power unit. The surveillance camera is configurable between the sleep mode and a deep sleep mode where the surveillance camera consumes less power than in the sleep mode. The control unit is configured to transition the surveillance camera from the sleep mode to the deep sleep mode when a power level of the power unit reaches a pre-set deep sleep power level threshold and to transition the surveillance camera from the deep sleep mode to the sleep mode when the power unit charged by the photovoltaic system reaches a pre-set deep sleep recovery power level threshold.

In accordance with another general aspect, there is also provided a method of autonomously capturing images by a surveillance camera having a control unit and an image sensor. The method comprises the steps of: maintaining the surveillance camera in a sleep mode; detecting a presence of a subject within limits of subject detection parameters using a subject detection sensor, a length of time wherein the presence of the subject within the limits of the subject detection parameters is detected defining a subject detection time period; temporarily transitioning the surveillance camera from the sleep mode to an active mode where the camera consumes more power, upon detection of the presence of the subject within the limits of the subject detection parameters; and successively capturing images during the subject detection time period where the subject detection sensor detects the presence of the subject within the predetermined perimeter. The image sensor and the control unit of the surveillance camera being constantly activated during the subject detection time period.

In an embodiment, the surveillance camera comprises a microcontroller and a main processor operatively connected to one another. The step of successively capturing images during the subject detection time period comprises constantly keeping the microcontroller and the main processor activated during the subject detection time period.

In an embodiment, the main processor is operatively connected to a combination of a serial flash memory and a parallel flash memory, with instructions executable by the main processor for performing transition between the sleep mode and the active mode being stored on the combination of the serial flash memory and parallel flash memory. The method further comprises the steps of initially executing the instructions stored on the serial flash memory and subsequently executing the instructions stored on the parallel flash memory to perform the transition of the surveillance camera between the sleep mode and the active mode.

In an embodiment, the method further comprises the steps of: repeatedly detecting whether the subject is still present within the limits of the subject detection parameters; and configuring the surveillance camera in the sleep mode once the subject detection sensor detects no presence of the subject within the limits of the subject detection parameters for at least a non-detection time period.

In an embodiment, the non-detection time period ranges between about 40 milliseconds and about 100 milliseconds.

In an embodiment, the surveillance camera comprises a photovoltaic module and a power unit operatively connected to the photovoltaic module. The method includes the steps of: charging the power unit using the photovoltaic module; and temporarily transitioning the surveillance camera from the sleep mode to a deep sleep mode where the surveillance camera consumes less power than in the sleep mode if the power level of the power unit reaches a pre-set deep sleep power level threshold, the surveillance camera being maintained in the deep sleep mode until the power unit charged by the photovoltaic system reaches a pre-set deep sleep recovery power level threshold.

In accordance with another general aspect, there is further provided a method of autonomously capturing images by a surveillance camera having a photovoltaic module and a power unit operatively connected to the photovoltaic module. The method comprises the steps of: charging the power unit using the photovoltaic module; maintaining the surveillance camera in a sleep mode; detecting a presence of a subject within limits of subject detection parameters using a subject detection sensor and temporarily transitioning the surveillance camera from the sleep mode to an active mode upon detection of the presence of the subject within the limits of the subject detection parameters; and temporarily transitioning the surveillance camera from the sleep mode to a deep sleep mode where the surveillance camera consumes less power than in the sleep mode if the power level of the power unit reaches a pre-set deep sleep power level threshold. The surveillance camera is maintained in the deep sleep mode until the power unit charged by the photovoltaic system reaches a pre-set deep sleep recovery power level threshold.

In an embodiment, the surveillance camera comprises an image sensor and a control unit and a length of time where the presence of the subject within the predetermined perimeter is detected defines a subject detection time period. The method further comprises successively capturing images during the subject detection time period where the subject detection sensor detects the presence of the subject within the limits of the subject detection parameters, with the image sensor and the control unit of the surveillance camera being constantly activated during the subject detection time period.

In an embodiment, the control unit of the surveillance camera comprises a microcontroller and a main processor operatively connected to one another. The step of successively capturing images during a subject detection time period comprises constantly keeping the microcontroller and the main processor activated during the subject detection time period.

In an embodiment, the main processor is operatively connected to a combination of a serial flash memory and a parallel flash memory, with instructions executable by the main processor for performing transition between the sleep mode and the active mode being stored on the combination of the serial flash memory and parallel flash memory. The method further comprises the steps of initially executing the instructions stored on the serial flash memory and subsequently executing the instructions stored on the parallel flash memory to perform the transition of the surveillance camera between the sleep mode and the active mode.

In an embodiment, the method further comprises the steps of: repeatedly detecting whether the subject is still present within the limits of the subject detection parameters; and configuring the surveillance camera in the sleep mode once the subject detection sensor detects no presence of the subject within the limits of the subject detection parameters for at least a non-detection time period.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a front elevation view of the surveillance camera, in accordance with an embodiment.

FIG. 2 is a front elevation view of the surveillance camera of FIG. 1, shown with a protective casing in an open configuration.

FIG. 3 is a schematic representation of the internal components of the surveillance camera of FIG. 1, in accordance with an embodiment.

FIG. 4 is a schematic representation of the control unit of the surveillance camera of FIG. 1, in accordance with an embodiment.

FIG. 5 is a flow chart of a sequence of operation of the surveillance camera of FIG. 1 for transition between a sleep mode and a deep sleep mode, in accordance with an embodiment.

FIG. 6 is a flow chart of a sequence of operation of the surveillance camera of FIG. 1 for image capture, in accordance with an embodiment.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Although the embodiments as illustrated in the accompanying drawings comprises particular steps of a method, not all of these steps are essential and thus should not be taken in their restrictive sense. It is to be understood, as also apparent to a person skilled in the art, that other steps, sequence of steps may be used and the steps can be performed in a different order, as will be briefly explained herein and as can be easily inferred herefrom, by a person skilled in the art, without departing from the scope of the invention.

Moreover, although the embodiments of the surveillance camera and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the surveillance camera, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

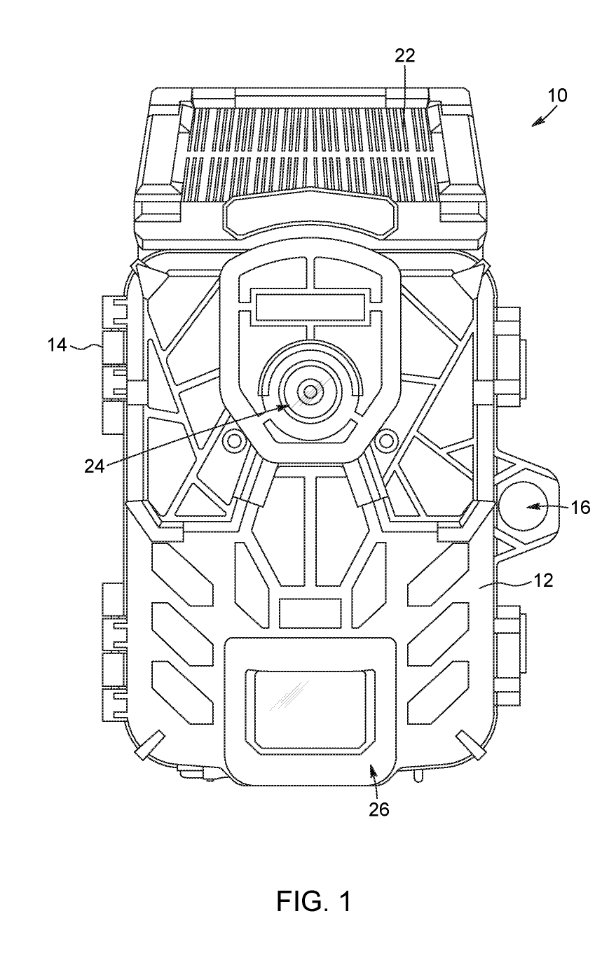

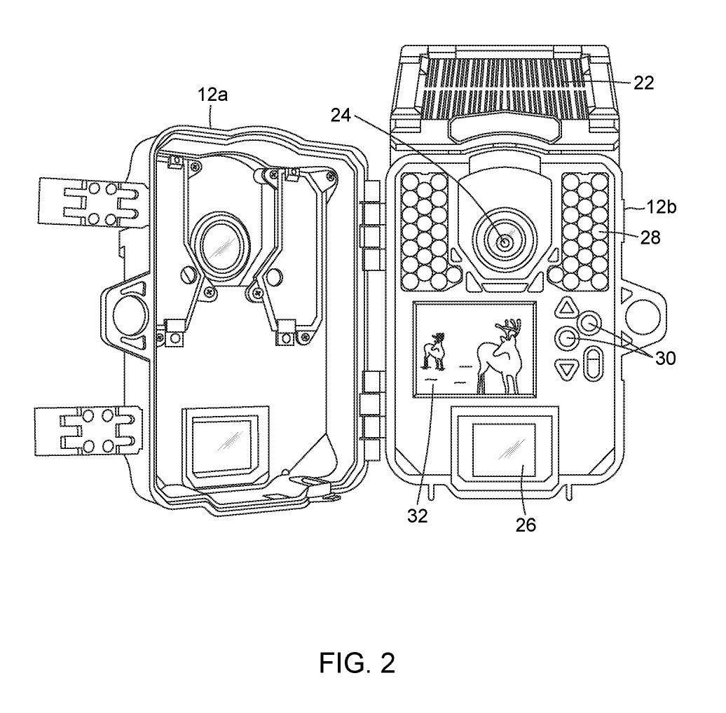

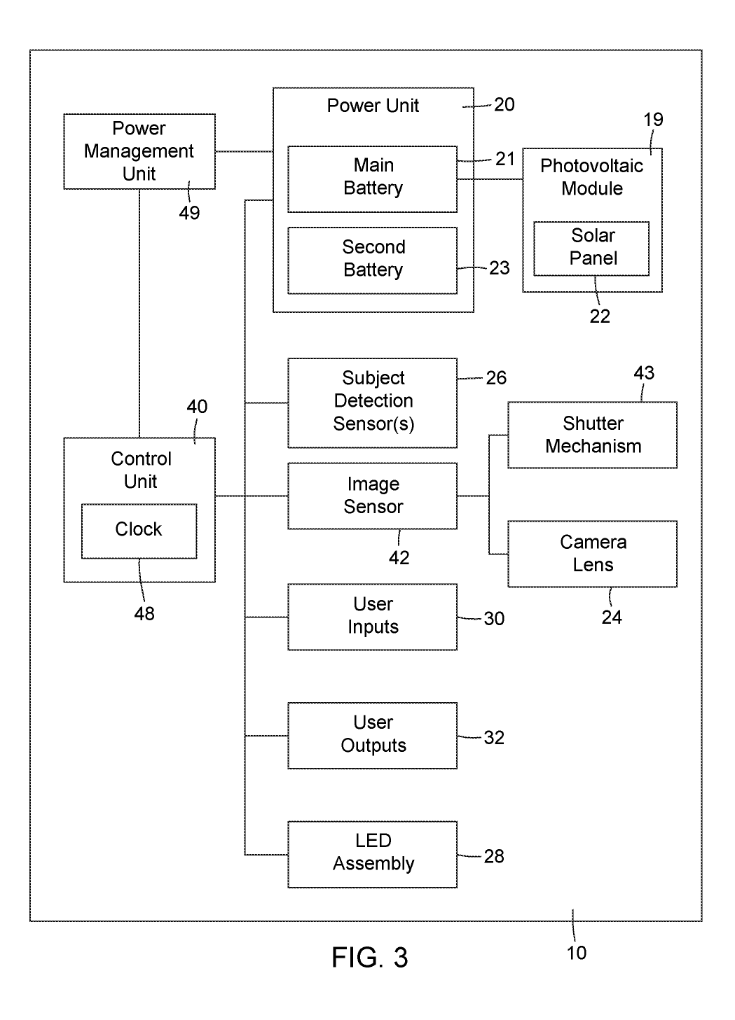

Referring generally to FIGS. 1 to 4, there is provided a surveillance camera 10 in accordance with an embodiment. The surveillance camera 10 is configured to be used, for example and without being limitative, for capturing images of subjects in the context of hunting, general wildlife surveillance, security purposes or the like. The surveillance camera 10 generally includes a protective casing 12 configurable between a closed configuration (see FIG. 1) and an open configuration (see FIG. 2). The protective casing 12 includes a front section 12a and a rear section 12b hingedly connected to one another by a hinge 14, to allow the protective casing 12 to be shifted between the closed configuration and the open configuration.

One skilled in the art will understand that the protective casing 12 is a housing configured to receive therein and protect the inner components of the surveillance camera 10, which will be described in more details below. In an embodiment, the protective casing 12 is made of plastic, such as acrylic, but one skilled in the art will understand that, in alternative embodiments, the protective casing 12 can be made of other materials offering sufficient rigidity to provide protection to the internal components, such as metal, other composite materials, or the like. In an embodiment, when configured in the closed configuration, the protective casing 12 is substantially sealed to shield the internal components of the camera 10 from outer elements, such as water, dust or the like. Hence, the protective casing 12 is waterproof and prevents water, such as rain water, from reaching and damaging the internal components of the camera 10 when the camera 10 is left outside for extended surveillance time periods. In an embodiment, the protective casing 12 further includes a locking aperture 16 defined in each one of the front section 12a and the rear section 12b to allow the protective casing 12 to be locked in the closed configuration, for example using a locking cable (not shown), a padlock (not shown) or the like.

The surveillance camera 10 also includes internal components (i.e. components at least partially located inside the protective casing 12) cooperating to allow the camera 10 to perform autonomous capture of still images and/or videos of a subject, such as a wildlife subject. In an embodiment, the internal components include at least one subject detection sensor(s) 26, a control unit 40, an image sensor 42, a camera lens 24, a shutter mechanism 43, a power unit 20 and a power management unit 49 (or power management chip) operatively connected at least to the power unit 20 and the control unit 40. One skilled in the art will understand that, additional conventional components commonly found in cameras, such as without being limitative, user inputs 30 which allow users to interact with the surveillance camera 10, user outputs 32 (i.e. display screen, lights, etc.) for displaying user information, light-emitting diode (LED) assembly 28 activable to capture image in low light conditions, or the like can also be included in the internal components of the surveillance camera 10.

The at least one subject detection sensor(s) 26 is operative to detect a presence of a subject within a predetermined perimeter surrounding the surveillance camera 10 (and in a field of view thereof) and cooperates with other internal components of the surveillance camera 10 to capture images of the subject, while the subject is within the field of view of the surveillance camera 10. One skilled in the art will understand that the subject detection sensor(s) 26 can include several possible types of sensor(s) operative to detect the presence of a subject within a predetermined perimeter. For example and without being limitative, in an embodiment, the subject detection sensor(s) 26 can include a motion sensor, a heat sensor, or other similar sensors, or a combination thereof. For example and without being limitative, in an embodiment, the subject detection sensor is a pyroelectric infrared (PIR) motion sensor, such as, without being limitative, a RE200B PIR sensor.

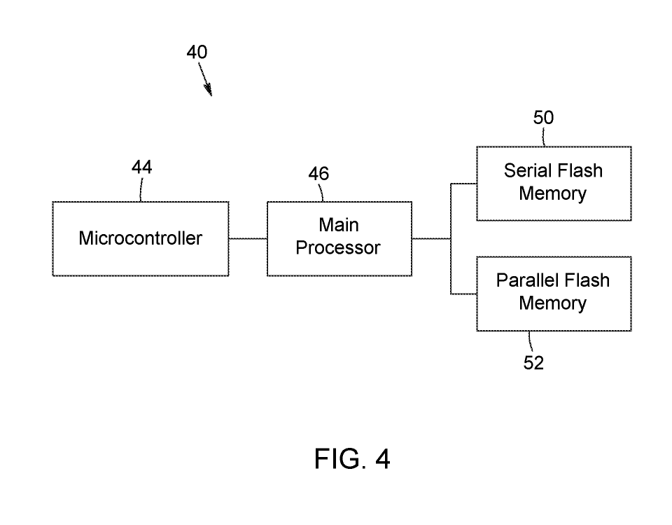

The control unit 40 provides various control functions, as will be described in more details below and includes a clock 48 for timing purposes. One skilled in the art will understand that the control unit 40 can be embodied by several elements cooperating to provide the control functions necessary to the operation of the surveillance camera 10. For example and without being limitative, in the embodiment shown in FIG. 4, the control unit 40 includes a microcontroller 44 operative to provide general control functions for the operation of the surveillance camera 10 and a main processor 46 operatively connected to the microcontroller 44 using known communication components, technologies and/or methods and operative to provide advanced control functions and process data relative to the capture of images by the surveillance camera 10. The main processor 46 is connected to necessary firmware and/or peripherals, such as, without being limitative Random-access memory (RAM) and/or Read-only memory ROM including instructions, for providing the advanced control functions. For example and without being limitative, in an embodiment, the main processor is a SQ917B processor from SQ and the microcontroller is a Renesas RL78 microcontroller. One skilled in the art will understand that, in alternative embodiments (not shown) the control unit 40 can include other components, different than the embodiment shown. For example and without being limitative, in an embodiment (not shown), the control unit 40 can include a single control chip (i.e. a single microcontroller and/or a single microprocessor with the necessary firmware and/or peripherals, or the like) or more than two control chips operatively connected to one another and/or to the necessary firmware.

The image sensor 42 is operative to photoelectrically convert a captured image into digital data. The image sensor 42 operates in combination with the camera lens 24 being configured for focusing light towards the image sensor 42 and the shutter mechanism 43 selectively exposing the image sensor 42 to light to capture images. The image sensor 42 includes any type of sensor operative to capture light and convert the captured light into electrical signals, such as for example and without being limitative, a Complementary Metal-Oxide-Semiconductor (CMOS) sensor which includes an array of pixel sensors, with each pixel sensor including a photodetector. For example and without being limitative, in an embodiment, the image sensor is a MT9P001 5 Mega pixel image sensor from Aptina. One skilled in the art will understand that, in an alternative embodiment, other types of images sensors, such as a Charge-Coupled Device (CCD) sensor can also be used.

The power unit 20 provides the power required for powering the components of the surveillance camera 10. In an embodiment, the power unit 20 includes a main battery 21 operatively connected to a photovoltaic module 19 including a solar panel 22. The photovoltaic module 19 recharges the main battery 21, thereby allowing the surveillance camera 10 to operate during an extended time period, without requiring input of outside electrical power. Several types and models of photovoltaic module 19 and solar panels 22 are known in the art for performing the above-described recharge of the main battery 21. For example and without being limitative, in an embodiment, the solar panel 22 has a photoelectric conversion rate of over 18.8%, with a working voltage of 5.5 V and a working current of 100 mA. In an embodiment, the solar panel 22 can work in temperatures of between about −20° C. and about 65° C. In an embodiment, the solar panel 22 is integrated or mounted to the protective casing 12, at an upper section thereof. One skilled in the art will understand that, in alternative embodiments (not shown), different positioning of the solar panel 22 with regard to the protective casing 12 can be provided, keeping in mind that the positioning and orientation of the solar panel 22 should allow installation of the surveillance camera 10 which favors the exposition of the solar panel 22 to sunlight.

In an embodiment, the main battery 21 includes at least one rechargeable battery for powering the components of the surveillance camera 10. In an embodiment, the main battery 21 is built-in within the surveillance camera 10 and includes Lithium-Ion or Ni—MH batteries of 4000 mAh. One skilled in the art will understand that, in alternative embodiments (not shown), the main battery 21 could also be removably connectable to the surveillance camera 10 and can include different amounts and types of batteries than the embodiment described above.

In an embodiment, a secondary battery 23 can also be provided. The secondary battery 23 operates as a backup of the main battery 21. In other words, the secondary battery 23 comprises at least one battery used to power the components of the surveillance camera 10, when the power level of the main battery 21 is below a minimal power level threshold (i.e. when the power level of the main battery 21 is insufficient to provide the required power to the components of the surveillance camera 10 for the surveillance camera 10 to operate). The at least one battery of the secondary battery 23 can be rechargeable or non-rechargeable. In an embodiment (not shown) where the at least one battery of the secondary battery 23 is rechargeable, the photovoltaic module 19 can be used to recharge the at least one battery of the secondary battery 23, for example, when the at least one battery of the main battery 21 is fully charged or above a predetermined threshold.

In the embodiment shown, the power unit 20 of the surveillance camera 10 includes a secondary battery 23 and the control unit 40 is configured to use power from the secondary battery 23 while the level of the main battery 21 is below a pre-set minimal power level threshold. In such an embodiment, power from the secondary battery 23 can be used when the main battery 21 reaches the minimal power level threshold and until a pre-set recovery power level threshold is reached. The recovery power level threshold is a power level threshold of the main battery 21 which is sufficient to allow the camera 10 to operate normally using the main battery 21, without power issues (i.e. without being too close to reaching a power level that is insufficient to provide the required power to the components of the surveillance camera 10). In other words, power from the secondary battery 23 can be used until the photovoltaic module 19 has sufficiently recharged the main battery 21 to reach the recovery power level threshold. In an embodiment, the minimal power level threshold ranges between about 10% and about 30% of the power level of the main battery 21 and the recovery power level threshold ranges between about 50% and about 90% of the power level of the main battery 21. In an alternative embodiment, the recovery power level threshold ranges between about 70% and about 90% of the power level of the main battery 21.

In an embodiment, the power management unit 49 is operatively connected to the power unit 20 and the control unit 40 of the surveillance camera and manages power attribution from the power unit 20 to the control unit 40. In an embodiment, power attribution to other components is subsequently managed by the control unit 40.

Now referring to FIGS. 4 to 6, in an embodiment, the control unit 40 is configured to selectively configure the surveillance camera 10 between an active mode and a sleep mode, in order to allow extended battery life. In the active mode, the surveillance camera 10 is fully operative to capture images and/or videos. In the sleep mode, the surveillance camera 10 is configured to minimize power consumption and therefore is still running but with minimal functions allowing the surveillance camera to remain operational. In an embodiment, the surveillance camera 10 is configured in the sleep mode by default and brought to the active mode when image capture is requested. For example and without being limitative, image capture can be requested upon occurrence of a triggering event, such as, for example and without being limitative when a presence of a subject is detected by the subject detection sensor(s) 26, as will be described in more details below.

Referring to FIG. 4, in an embodiment, the instructions relative to the transition between the sleep mode and the active mode (i.e. the instructions stored in a memory to perform the method allowing transition between the sleep mode and the active mode) are stored on a combination of a serial flash memory 50 and a parallel flash memory 52 operatively connected to the main processor 46, using known communication components, technologies and/or methods. One skilled in the art will understand that several types and models of memories can be used for each one of the serial flash memory 50 and the parallel flash memory 52. For example and without being limitative, in an embodiment, the serial flash memory 50 is a flash SPI Windbond 25q80dvsig flash memory and the parallel flash memory 52 is a NAND Hynix hy27us0812 flash memory.

In an embodiment, the control unit 40 is configured, such that, when transitioning from the sleep mode to the active mode, the main processor 46 initially boots on (or uses) the serial flash memory 50 (i.e. the main processor 46 initially executes the instructions stored on the serial flash memory 50) and subsequently boots on (or uses) the parallel flash memory 52 (i.e. the main processor 46 subsequently executes the instructions stored on the parallel flash memory 52) to perform the transition between the sleep mode and the active mode. The use of the above-described combination of the serial flash memory 50 and the parallel flash memory 52 by the control unit 40 with the above described booting sequence, allows a faster execution of the overall instructions and therefore leads to a smaller trigger time of the surveillance camera 10.

In an embodiment, the use of the above-mentioned combination of a serial flash memory 50 and a parallel flash memory 52 operatively connected to the main processor 46, with the above described booting sequence, allows the surveillance camera 10 to have a response time below about 0.10 second. More particularly, in an embodiment, the use of the above-mentioned combination of a serial flash memory 50 and a parallel flash memory 52 operatively connected to the main processor 46, with the above described booting sequence, allows the surveillance camera 10 to have a response time of about 0.07 second. Such a response time is significantly faster than response times previously measured, when only parallel flash memory is used where tests have shown a response time of more than about 0.2 second, and more particularly of about 0.28 second.

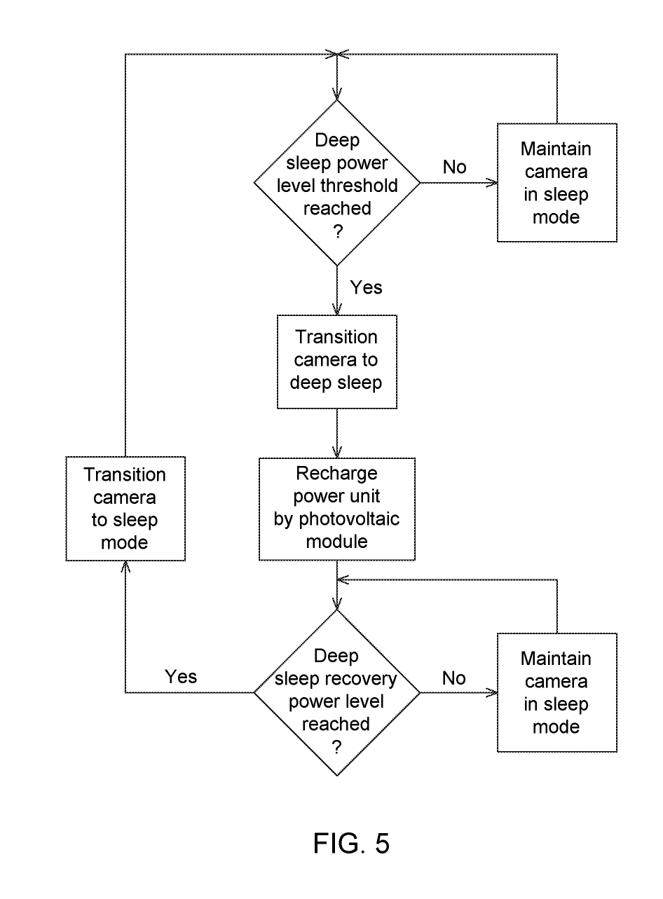

Referring to FIG. 5, in an embodiment, the control unit 40 is further configured to selectively configure the surveillance camera 10 in a deep sleep mode if the power level of the power unit 20 (including the main battery 21 and optional secondary battery 23) reaches a pre-set deep sleep power level threshold. In the deep sleep mode, minimal power consumption is used by the surveillance camera 10 while the power unit 20 of the surveillance camera 10 is being recharged and the surveillance camera 10 thereby consumes less power than in the sleep mode. In such an embodiment, minimal powering of only critical components of the surveillance camera 10, such as and without being limitative, the clock 48 and the power management unit 49, is maintained. Such minimal powering of the critical components allows the surveillance camera 10 to resume from the point where deep sleep mode was initiated when the surveillance camera 10 is restored to the sleep mode, from the deep sleep mode, without losing the data and base settings of the surveillance camera 10 (such as time and date). Hence, when the surveillance camera 10 is restored to the sleep mode, from the deep sleep mode, it can use current time, date and previously stored data and user settings. When in the deep sleep mode, the surveillance camera 10 is not operative to capture images (i.e. the surveillance camera 10 cannot be transitioned to the active mode even upon occurrence of a triggering event). In an embodiment, the surveillance camera 10 is maintained in the deep sleep mode until the power unit 20 reaches a pre-set deep sleep recovery power level threshold sufficient to allow the camera 10 to operate normally. When the pre-set deep sleep recovery power level threshold is reached (i.e. when the photovoltaic module 19 has sufficiently recharged the power unit 20 to reach the pre-set deep sleep recovery power level threshold), the control unit 40 restores the surveillance camera 10 to the sleep mode and normal operation thereof is resumed.

In an embodiment where the power unit 20 includes only a main battery 21, the pre-set deep sleep power level threshold can range between about 10% and about 30% of the power level of the main battery 21 of the power unit 20 and the pre-set deep sleep recovery power level threshold can range between about 50% and about 90% of the power level of the main battery 21 of the power unit 20. In an alternative embodiment, the pre-set deep sleep recovery power level threshold can range between about 70% and about 90% of the power level of the main battery 21 of the power unit 20.

In an embodiment where the power unit 20 includes a main battery 21 and a secondary battery 23, the pre-set deep sleep power level threshold can range between about 10% and about 30% of the power level of the main battery 21 and the secondary battery 23 of the power unit 20. In other words, the pre-set deep sleep power level is reached when both the main battery 21 and the secondary battery 23 have reached a power level of between about 10% and about 30%. The pre-set deep sleep recovery power level threshold can range between about 50% and about 90% of the power level of the main battery 21 of the power unit 20. In an alternative embodiment, the pre-set deep sleep recovery power level threshold can range between about 70% and about 90% of the power level of the main battery 21 of the power unit 20.

As mentioned above, in an embodiment, when the surveillance camera 10 is configured in the deep sleep mode, only the power management unit 49 and the clock 48 are functional (i.e. only the power management unit 49 and the clock 48 are at least minimally powered to allow operation thereof), the other components of the surveillance camera 10 being temporarily shut down to minimize power consumption from the power unit 20. In an embodiment, in the deep sleep mode, the power management unit 49 is powered by one of the photovoltaic module 19 or the main battery 21 of the power unit 20. In an embodiment, the clock 48 is powered using a dedicated clock battery, thereby remaining powered and active in all modes (i.e. the deep sleep mode, sleep mode and active mode). In an embodiment, in the deep sleep mode, the surveillance camera 10 consumes about 20 uW or less.

In an embodiment, when the surveillance camera 10 is configured in the sleep mode, the power management unit 49, the subject detection sensor(s) 26, the control unit 40 (and clock 48 thereof) and the image sensor 42 are functional. It will be understood that, in the sleep mode, the power management unit 49, the subject detection sensor(s) 26, the control unit 40 (and clock 48 thereof) and the image sensor 42 are maintained in a minimally powered state, not to be shut down, but still are not fully operational, thereby allowing the surveillance camera 10 to consume a low power quantity. In an embodiment, in the sleep mode, the image sensor 42 is powered through a sleep pin of the image sensor 42 which allows minimal powering thereof, for example, to maintain image sensor settings, while the surveillance camera 10 remains in the sleep mode.

To minimize the downtime of the surveillance camera 10 (i.e. the period of time the surveillance camera 10 needs to be switched to the deep sleep mode), the surveillance camera 10 is configured for low power consumption. To achieve such low power consumption, the surveillance camera 10 is configured to minimize “trigger time” (i.e. the lapse of time between motion detection and the taking of a picture by the camera) and “recovery time” (i.e. the lapse of time between motion detection and when the camera is ready to trigger again (including the trigger time)), which are the time periods where the camera consumes the most energy.

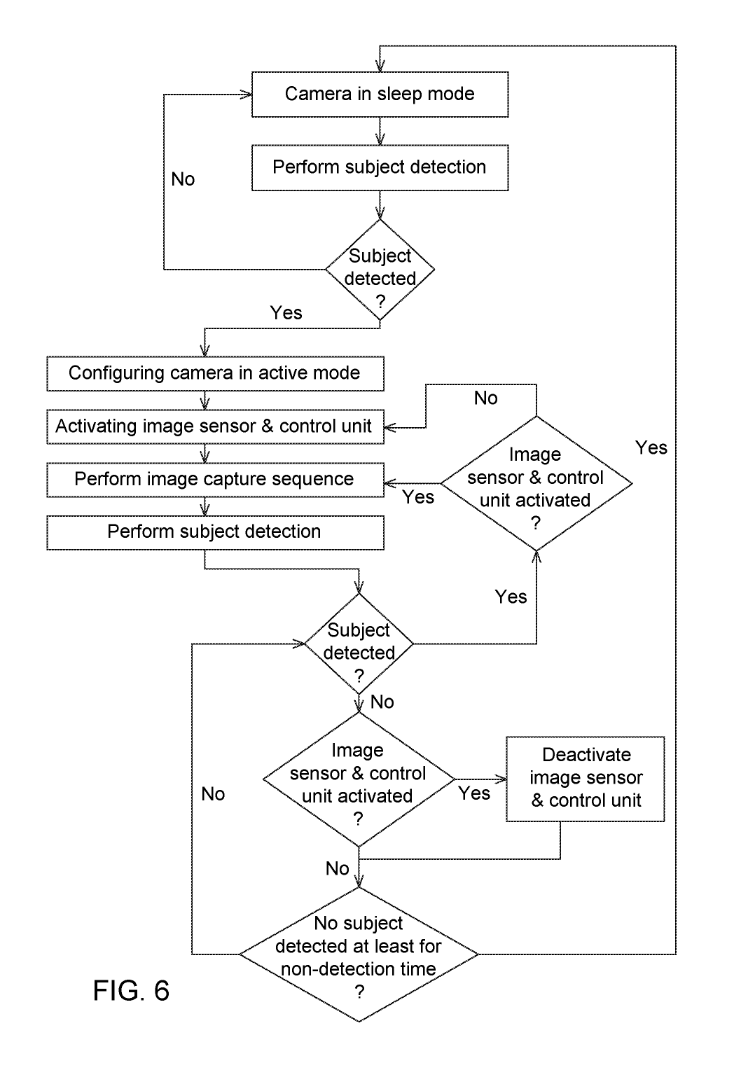

Referring to FIG. 6, as mentioned above, when the surveillance camera 10 is in the sleep mode, the control unit 40 is configured to initiate the capture of at least one image, upon occurrence of a triggering event. In other words, the control unit 40 is configured to initiate the capture of at least one image when image capture is requested, for example following the detection of a subject by the subject detection sensor(s) 26. It will be understood that, in an embodiment, subject detection parameters which cause a triggering event can be customised to match a user's needs. For example and without being limitative, a detection range, a movement detection threshold, a movement time threshold or the like can be pre-set in the surveillance camera 10, according to the user preference, to minimize the occurrence of a false detection by a movement sensor of the subject detection sensor(s) 26. As mentioned above, in an embodiment, subject detection can also be performed using other sensor types than a movement sensor, such as, without being limitative, a heat detector or the like according to subject detection parameters. In an embodiment, the predetermined detection range can be between about 2 meters and about 40 meters. In an embodiment, a detection angle can be between about 40° and about 160°.

In the course of the present document, the term “image capture” is used to define the capture of at least one image of a subject, including still images and videos thereof. Hence, it will be understood that the term “image capture” can be used for the capture of a single still image and/or video or for a plurality of successive still images and/or videos. For example and without being limitative, in an embodiment, the surveillance camera 10 includes an instant picture mode wherein successive images are captured (for example and without being limitative at a rate of between 1 image/second and 3 images/second), upon the occurrence of a triggering event and during the time period that the subject(s) remains within the limits of the subject detection parameters. In an embodiment, the surveillance camera 10 can also include a multi-picture mode wherein a pre-set maximum of still images (for example 6 still images) can be captured, with a predetermined delay (for example 5 seconds between each), upon occurrence of a triggering event. One skilled in the art will understand that, in alternative embodiments, a different number of images, with a different delay between each, could be used in the multi-picture mode.

Upon occurrence of a triggering event (e.g. upon detection of a subject within the limits of the subject detection parameters by the subject detection sensor(s) 26), the surveillance camera 10 is brought to the active mode. In the active mode, the power management unit 49, the subject detection sensor(s) 26, the control unit 40 and the image sensor 42 are fully operational (i.e. they are powered and awake and can be activated without delay to perform image capture) without necessarily being currently activated (i.e. without being necessarily fully powered to actually perform their task).

Upon occurrence of the triggering event, following the transition of the surveillance camera 10 to the active mode, the image sensor 42 and the control unit 40 are activated. In other words, the image sensor 42 is sufficiently powered to allow the image sensor 42 to capture light and convert the captured light into electrical signals and the control unit 40 is sufficiently powered to allow the capture of an image, processing of the image data and storage of the processed image data. Subsequently, at least one image capture sequence is executed to perform image capture of a scene/subject. In an embodiment, the image capture sequence comprises activation of the shutter mechanism 43 such that light momentarily enters the surveillance camera 10, is focused by the camera lens 24 onto the array of pixel sensors of the image sensor 42 and is converted into a digital image of the captured scene/subject by the image sensor 42.

As mentioned above, when the surveillance camera 10 is set to the instant picture mode, successive image capture sequences can be performed to achieve the capture of a plurality of images in rapid succession by the surveillance camera 10. In the embodiment shown where the control unit 40 includes a microcontroller 44 and main processor 46, when the surveillance camera 10 is set to the instant picture mode, to minimize the trigger time, the image sensor 42 and the microcontroller 44 and main processor 46 of the control unit 40 can be kept activated during the entire time period of the successive image capture sequences (i.e. from the time of the triggering event until the capture of the last image of the plurality of images or the determination that the subject is not detected by the subject detection sensor(s) 26). In other words, in such an embodiment, the image sensor 42 and the microcontroller 44 and main processor 46 of the control unit 40 can be kept activated during a subject detection time period corresponding to the entire time period where the presence of a subject is detected by the subject detection sensor(s) 26 (and is within the limits of the pre-set subject detection parameters) and wherein the surveillance camera 10 constantly captures images in rapid succession.

As can be seen in FIG. 6, in the embodiment shown, to perform constant activation of the image sensor 42 and the microcontroller 44 and main processor 46 of the control unit 40 during the successive image capture sequences, the image sensor 42 and the microcontroller 44 and main processor 46 of the control unit 40 are initially activated upon occurrence of the triggering event (i.e. upon detection of a subject within the limits of the pre-set subject detection parameters by the subject detection sensor(s) 26) and a first image is captured. Once the first image has been captured, the image sensor 42 and the microcontroller 44 and main processor 46 of the control unit 40 are kept activated while determination of whether an additional image is to be captured (i.e. during the determination of whether a subject is still within the limits of the subject detection parameters of the subject detection sensor(s) 26 between the capture of successive images). In an embodiment, the subject detection sensor(s) 26 perform subject detection (i.e. detects whether a subject is still within the limits of the subject detection parameters of the subject detection sensor(s) 26)) at regular interval, such as, without being limitative, every millisecond. In an embodiment, the intervals at which the subject detection sensor(s) 26 perform subject detection is smaller than the interval at which each successive image is captured, for example and without being limitative at a rate of between 1 image/second and 3 images/second. Hence, in such an embodiment, the image sensor 42 and the microcontroller 44 and main processor 46 of the control unit 40 are kept activated between the capture of successive images, if a subject is detected within the limits of the subject detection parameters of the subject detection sensor(s) 26 during the entire period between the capture of successive images. When the subject is not detected within the limits of the subject detection parameters of the subject detection sensor(s) 26, the the image sensor 42 and the microcontroller 44 and main processor 46 of the control unit 40 can be deactivated immediately.

In an embodiment, when the surveillance camera 10 is configured in the instant picture mode, after image capture has been performed (i.e. following the occurrence of a triggering event), the control unit 40 is configured to return the surveillance camera 10 to the sleep mode, to minimize power consumption thereof. However, in the embodiment shown in FIG. 6, in order to minimize the recovery time, before transitioning from the active mode to the sleep mode, the control unit 40 is configured to monitor the presence of the subject within the limits of the subject detection parameters of the subject detection sensor(s) 26 (i.e. determine whether the subject detection sensor(s) 26 detects the presence of a subject within the limits of the subject detection parameters during a time period) and to transition the surveillance camera 10 to the sleep mode only if no presence of a subject is detected during a pre-set non-detection time period.

In an embodiment, such determination of whether there is still a presence of the subject within the predetermined perimeter, is performed by the control unit 40 using the subject detection sensor(s) 26 sensing if a subject is still within the limits of the subject detection parameters. During the presence of a subject within the limits of the subject detection parameters of the subject detection sensor(s) 26, as mentioned above, the surveillance camera 10 is kept in the active mode, with the image sensor 42 and the microcontroller 44 and main processor 46 of the control unit 40 activated. If no presence of a subject within the limits of the subject detection parameters of the subject detection sensor(s) 26 is detected, the surveillance can still be maintained in the active mode until a pre-set non-detection time period has elapsed (i.e. while no subject has been detected during a time period shorter than the pre-set non-detection time period). When no presence of a subject within the limits of the subject detection parameters of the subject detection sensor(s) 26 is detected during at least the pre-set non-detection time period, the control unit 40 can perform the transition of the surveillance camera 10 from the active mode to the sleep mode. For example and without being limitative, in an embodiment, the control unit 40 is configured to perform the transition of the surveillance camera 10 from the active mode to the sleep mode after no subject has been detected by the detection sensor(s) 26 within the limits of the subject detection parameters for a non-detection time period of between about 40 milliseconds and about 100 milliseconds.

The transition of the surveillance camera 10 from the active mode to the sleep mode only after no subject has been detected during the pre-set non-detection time period (or, in other words, only after an absence of subject detection during a pre-set non-detection time period) minimizes the occurrences of numerous successive transitions between the active mode and the sleep mode, thereby minimizing the recovery time. Such a mechanism helps to transition the surveillance camera 10 from the active mode to the sleep mode only when such transition is desirable, i.e. only when, in all probabilities, no image capture is foreseeable in a near future.

In an embodiment, following the capture of each image, the main processor 46 can receive image data from the image sensor 42 and process the image data to maximise image quality. In an embodiment, the processed image data can subsequently be stored onto an image storage peripheral (not shown) such as, for example and without being limitative, an external memory card removably connectable to the surveillance camera 10, which can be subsequently retrieved by a user. In an embodiment, the surveillance camera 10 is configured to continuously store the new captured images. Hence, in the event where the image storage peripheral is full, the surveillance camera 10 is configured to overwrite the latest captured image(s) over the oldest image(s) stored onto the image storage peripheral. Such storage process ensures that the image storage peripheral includes all the latest captured images, even if this means overwriting the oldest images.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A surveillance camera comprising:
a power unit;
a control unit selectively powered by the power unit;
a subject detection sensor powered by the power unit and detecting a presence of a subject within limits of subject detection parameters, a length of time wherein the subject detection sensor detects the presence of the subject within the limits of the subject detection parameters defining a subject detection time period; and
an image sensor operatively connected to the subject detection sensor and the control unit, the image sensor and the control unit being constantly activated by the power unit during the subject detection time period where the subject detection sensor detects the presence of the subject within the limits of the subject detection parameters.

2. The surveillance camera of claim 1, wherein the control unit comprises a microcontroller and a main processor operatively connected to one another and wherein the microcontroller and the main processor are constantly activated by the power unit during the subject detection time period where the subject detection sensor detects the presence of the subject within the limits of the subject detection parameters.

3. The surveillance camera of claim 2, wherein the surveillance camera is configurable between an active mode and a sleep mode with the surveillance camera having a lower power consumption in the sleep mode than in the active mode and wherein the control unit is configured to perform transition of the surveillance camera from the sleep mode to the active mode upon detection of the presence of a subject within the limits of the subject detection parameters by the subject detection sensor.

4. The surveillance camera of claim 3, wherein the main processor is operatively connected to a combination of a serial flash memory and a parallel flash memory and wherein instructions executable by the main processor for performing transition between the sleep mode and the active mode are stored on the combination of the serial flash memory and the parallel flash memory.

5. The surveillance camera of claim 4, wherein the main processor is configured to initially execute the instructions stored on the serial flash memory and subsequently execute the instructions stored on the parallel flash memory to perform the transition of the surveillance camera between the sleep mode and the active mode.

6. The surveillance camera of claim 3, wherein the control unit is configured to transition the surveillance camera between the active mode and the sleep mode following an absence of detection of the presence of the subject within the limits of the subject detection parameters by the subject detection sensor during a time period equal or greater than a pre-set non-detection time period.

7. The surveillance camera of claim 6, wherein the non-detection time period ranges between about 40 milliseconds and about 100 milliseconds.

8. The surveillance camera of claim 3, wherein the surveillance camera comprises a photovoltaic module charging the power unit, the surveillance camera being configurable between the sleep mode and a deep sleep mode where the surveillance camera consumes less power than in the sleep mode and the control unit being configured to transition the surveillance camera from the sleep mode to the deep sleep mode when a power level of the power unit reaches a pre-set deep sleep power level threshold and to transition the surveillance camera from the deep sleep mode to the sleep mode when the power unit charged by the photovoltaic system reaches a pre-set deep sleep recovery power level threshold.

9. A method of autonomously capturing images by a surveillance camera having a control unit and an image sensor, the method comprising the steps of:
maintaining the surveillance camera in a sleep mode;
detecting a presence of a subject within limits of subject detection parameters using a subject detection sensor, a length of time wherein the presence of the subject within the limits of the subject detection parameters is detected defining a subject detection time period;
temporarily transitioning the surveillance camera from the sleep mode to an active mode where the camera consumes more power, upon detection of the presence of the subject within the limits of the subject detection parameters; and
successively capturing images during the subject detection time period where the subject detection sensor detects the presence of the subject within the predetermined perimeter, with the image sensor and the control unit of the surveillance camera being constantly activated during the subject detection time period.

10. The method of claim 9, wherein the surveillance camera comprises a microcontroller and a main processor operatively connected to one another and wherein the step of successively capturing images during the subject detection time period comprises constantly keeping the microcontroller and the main processor activated during the subject detection time period.

11. The method of claim 10, wherein the main processor is operatively connected to a combination of a serial flash memory and a parallel flash memory, with instructions executable by the main processor for performing transition between the sleep mode and the active mode being stored on the combination of the serial flash memory and parallel flash memory, the method further comprising the steps of initially executing the instructions stored on the serial flash memory and subsequently executing the instructions stored on the parallel flash memory to perform the transition of the surveillance camera between the sleep mode and the active mode.

12. The method of claim 9, further comprising the steps of:
repeatedly detecting whether the subject is still present within the limits of the subject detection parameters; and
configuring the surveillance camera in the sleep mode once the subject detection sensor detects no presence of the subject within the limits of the subject detection parameters for at least a non-detection time period.

13. The method of claim 12, wherein the non-detection time period ranges between about 40 milliseconds and about 100 milliseconds.

14. The method of claim 9, wherein the surveillance camera comprises a photovoltaic module and a power unit operatively connected to the photovoltaic module and wherein the method includes the steps of:
charging the power unit using the photovoltaic module; and
temporarily transitioning the surveillance camera from the sleep mode to a deep sleep mode where the surveillance camera consumes less power than in the sleep mode if the power level of the power unit reaches a pre-set deep sleep power level threshold, the surveillance camera being maintained in the deep sleep mode until the power unit charged by the photovoltaic system reaches a pre-set deep sleep recovery power level threshold.

15. A method of autonomously capturing images by a surveillance camera having a photovoltaic module and a power unit operatively connected to the photovoltaic module, the method comprising the steps of:
charging the power unit using the photovoltaic module;
maintaining the surveillance camera in a sleep mode;
detecting a presence of a subject within limits of subject detection parameters using a subject detection sensor and temporarily transitioning the surveillance camera from the sleep mode to an active mode upon detection of the presence of the subject within the limits of the subject detection parameters; and
temporarily transitioning the surveillance camera from the sleep mode to a deep sleep mode where the surveillance camera consumes less power than in the sleep mode if the power level of the power unit reaches a pre-set deep sleep power level threshold, the surveillance camera being maintained in the deep sleep mode until the power unit charged by the photovoltaic system reaches a pre-set deep sleep recovery power level threshold.

16. The method of claim 15, wherein the surveillance camera comprises an image sensor and a control unit and wherein a length of time where the presence of the subject within the predetermined perimeter is detected defines a subject detection time period, the method further comprising successively capturing images during the subject detection time period where the subject detection sensor detects the presence of the subject within the limits of the subject detection parameters, with the image sensor and the control unit of the surveillance camera being constantly activated during the subject detection time period.

17. The method of claim 16, wherein the control unit of the surveillance camera comprises a microcontroller and a main processor operatively connected to one another and wherein the step of successively capturing images during a subject detection time period comprises constantly keeping the microcontroller and the main processor activated during the subject detection time period.

18. The method of claim 17, wherein the main processor is operatively connected to a combination of a serial flash memory and a parallel flash memory, with instructions executable by the main processor for performing transition between the sleep mode and the active mode being stored on the combination of the serial flash memory and parallel flash memory, the method further comprising the steps of initially executing the instructions stored on the serial flash memory and subsequently executing the instructions stored on the parallel flash memory to perform the transition of the surveillance camera between the sleep mode and the active mode.

19. The method of claim 15, further comprising the steps of:
repeatedly detecting whether the subject is still present within the limits of the subject detection parameters; and
configuring the surveillance camera in the sleep mode once the subject detection sensor detects no presence of the subject within the limits of the subject detection parameters for at least a non-detection time period.
